(19) United States
(12) Patent Application Publication
(10) Pub. No.: US 2026/0264596 A1
(43) Pub. Date: Sep. 10, 2026

(54) TARPAULIN APPARATUS FOR LIFTING A PAYLOAD ONTO A VEHICLE

(71) Applicant: Gilles Gagnon, Espanola (CA)

(72) Inventor: Gilles Gagnon, Espanola (CA)

(21) Appl. No.: 19/069,864

(22) Filed: Mar. 4, 2025

(51) Int. Cl. B60P 1/43; B60P 7/08

(52) U.S. Cl. CPC B60P 1/43; B60P 7/0823

(57) ABSTRACT

A tarpaulin apparatus for lifting a payload onto a rack of a vehicle includes a flexible sheet in which each side edge of a pair of side edges of the flexible sheet extends between a front edge and a back edge of the flexible sheet. A front rigid board is coupled to the flexible sheet adjacent to the front edge. The front rigid board extends between the pair of side edges of the flexible sheet. A back rigid board is coupled to the flexible sheet adjacent to the back edge. The back rigid board extends between the pair of side edges of the flexible sheet. The tarpaulin apparatus is used in a method of lifting the payload onto the rack of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tarpaulin apparatuses and more particularly pertains to a new tarpaulin apparatus for lifting a payload onto a rack of a vehicle.

### (2) Description of Related Art Including Information Disclosed Under 37 CFR 1.97 and 1.98.

The prior art discloses various tarpaulin apparatuses for handling payloads. Often, these apparatuses are used to drag payloads across a ground surface. The prior art fails, however, to describe such an apparatus which is designed to facilitate loading of a payload onto a rack of a vehicle. The prior art also fails to describe such a method as may be useful in such situations.

### BRIEF SUMMARY OF THE INVENTION

An embodiment of the disclosure meets the needs presented above by generally comprising a flexible sheet in which each side edge of a pair of side edges of the flexible sheet extends between a front edge and a back edge of the flexible sheet. A front rigid board is coupled to the flexible sheet adjacent to the front edge. The front rigid board extends between the pair of side edges of the flexible sheet. A back rigid board is coupled to the flexible sheet adjacent to the back edge. The back rigid board extends between the pair of side edges of the flexible sheet.

Another embodiment of the disclosure includes a method of lifting a payload onto a rack of a vehicle. The method comprises positioning a flexible sheet of a tarpaulin apparatus over the rack of the vehicle such that the tarpaulin apparatus extends across and off of the rack and onto a ground surface positioned below an upper surface of the rack. A front edge of the flexible sheet is attached to the vehicle, and a back edge of the flexible sheet is attached to a support structure. The payload is positioned on the flexible sheet over the ground surface. The vehicle is then moved away from the support structure which thereby pulls the flexible sheet taut between the vehicle and the support structure. As a result, the flexible sheet extends horizontally between the back edge of the flexible sheet and the front edge of the flexible sheet. The payload is then moved across the flexible sheet to a carrying position in which the payload lies on the flexible sheet over the rack of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a tarpaulin apparatus according to an embodiment of the disclosure.

FIG. 2 is a detail view of an embodiment of the disclosure taken from Window 2 in FIG. 1.

FIG. 3 is an in-use view of an embodiment of the disclosure in which a payload is being placed on a flexible sheet of the embodiment in preparation to lift the payload.

FIG. 4 is an in-use view of an embodiment of the disclosure in which the vehicle has been moved away from the support structure such that the flexible sheet is pulled taut, lifting the payload.

FIG. 5 is an in-use view of an embodiment of the disclosure in which the payload is secured to the vehicle via the embodiment.

### DETAILED DESCRIPTION OF THE INVENTION

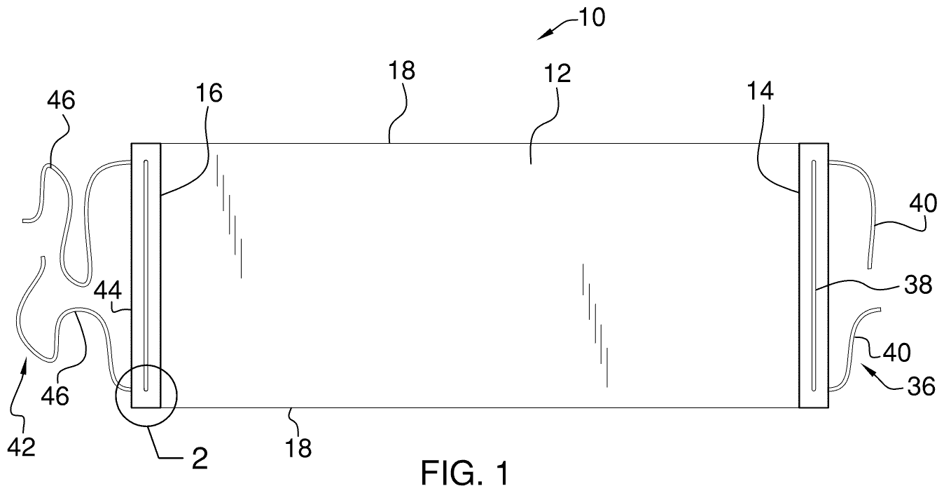

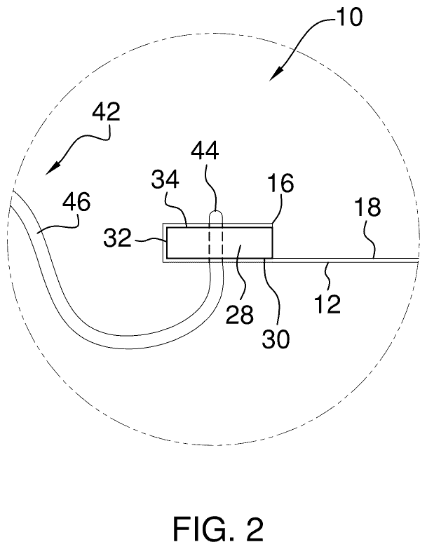

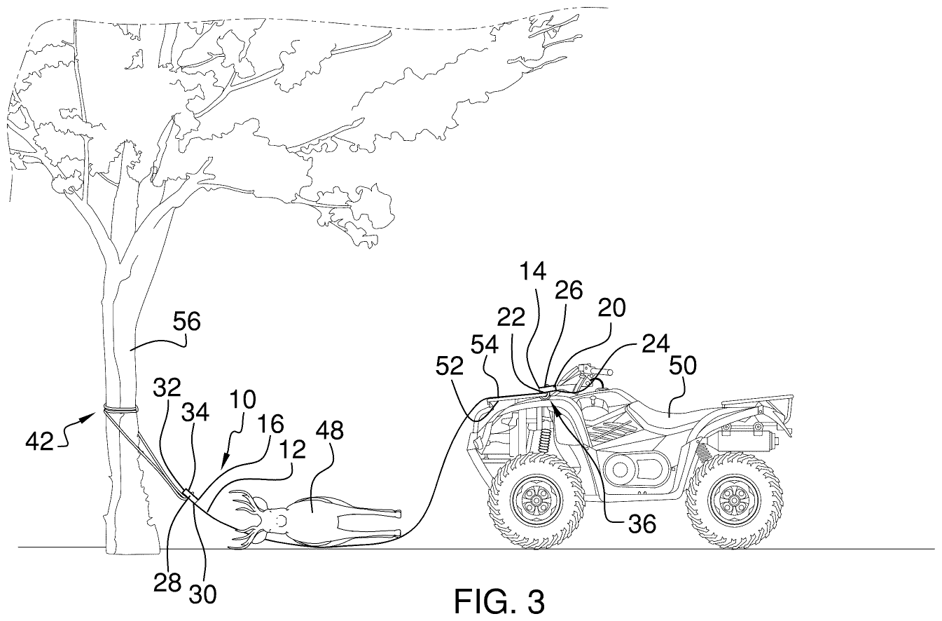

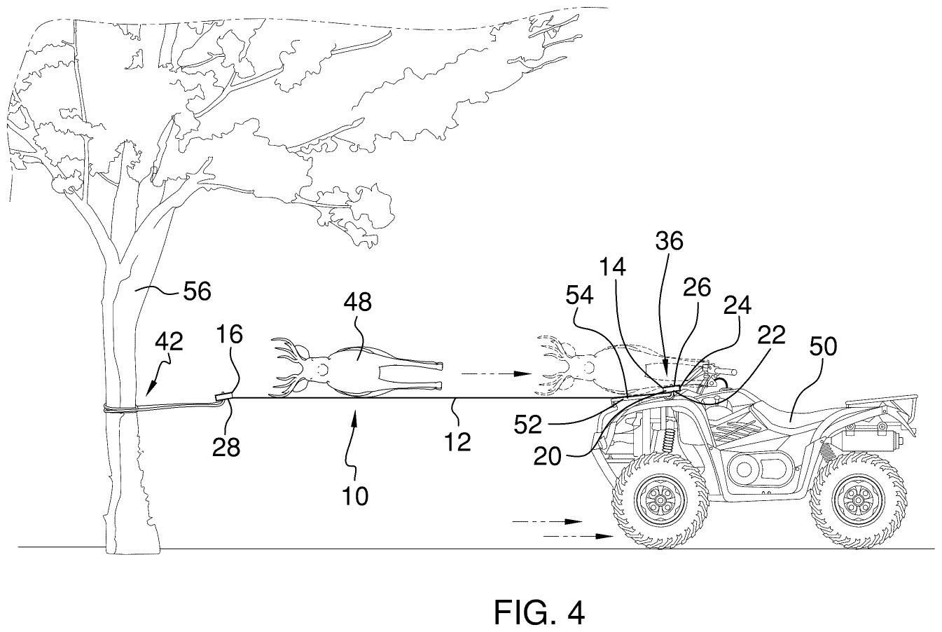

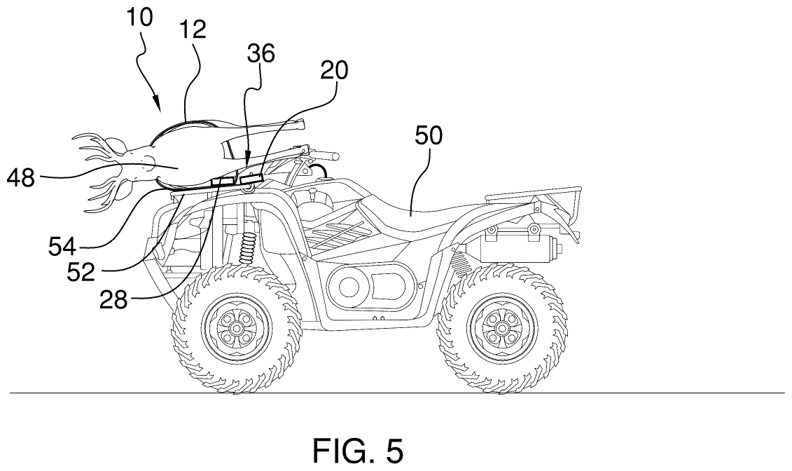

With reference now to the drawings, and in particular to FIGS. 1 through 5 thereof, a new tarpaulin apparatus embodying the principles and concepts of an embodiment of the disclosure and generally designated by the reference numeral 10 will be described.

As best illustrated in FIGS. 1 through 5, the tarpaulin apparatus 10 generally comprises a flexible sheet 12 which is elongated between a front edge 14 and a back edge 16. Each side edge 18 of a pair of side edges 18 of the flexible sheet 12 extends between the front edge 14 and the back edge 16 of the flexible sheet 12. A front rigid board 20 is coupled to the flexible sheet 12 adjacent to the front edge 14, and a back rigid board 28 is coupled to the flexible sheet 12 adjacent to the back edge 16. The front rigid board 20 and the back rigid board 28 extend between the pair of side edges 18 of the flexible sheet 12. The flexible sheet 12 is wrapped around a bottom side 22, a front side 24, and a top side 26 of the front rigid board 20 and is wrapped around a bottom surface 30, a back surface 32, and a top surface 34 of the back rigid board 28. The flexible sheet 12 may comprise any suitable flexible material such as polyester, canvas, nylon, polyethylene, or the like. The front rigid board 20 and the back rigid board 28 may comprise wood, metal, rigid plastic, or the like.

A front cord 36 is coupled to the front rigid board 20. The front cord 36 has a pair of end portions 40 and a central portion 38, wherein the central portion 38 is coupled to and extends between the pair of end portions 40. The central portion 38 of the front cord 36 lies against the flexible sheet 12 opposite the top side 26 of the front rigid board 20. Each end portion 40 of the pair of end portions 40 of the front cord 36 extends away from the central portion 38 through the flexible sheet 12, the front rigid board 20, and the flexible sheet 12 again.

A back cord 42 is coupled to the back rigid board 28. The back cord 42 has a pair of end sections 46 and a central section 44. The central section 44 is coupled to and extends between the pair of end sections 46. The central section 44 of the back cord 42 lies against the flexible sheet 12 opposite the top surface 34 of the back rigid board 28. Each end section 46 of the pair of end sections 46 of the back cord 42 extends away from the central section 44 through the flexible sheet 12, the back rigid board 28, and the flexible sheet 12 again.

The tarpaulin apparatus 10 is used in a method of lifting a payload 48 onto a rack 52 of a vehicle 50. The vehicle 50 may typically be an all-terrain vehicle (ATV), but any vehicle with a rack with space adjacent to the rack such that items may be translated horizontally onto the rack may be used. The payload 48 may be a game animal, a log, or any other item which may be suitable for transport on the rack 52 of the vehicle 50.

The method comprises positioning a flexible sheet 12 of a tarpaulin apparatus 10 over the rack 52 of the vehicle 50 such that the tarpaulin apparatus 10 extends across and off of the rack 52 and onto a ground surface positioned below an upper surface 54 of the rack 52. The front cord 36 is tied to the vehicle 50 to attach the front edge 14 of the flexible sheet 12 to the rack 52 of the vehicle 50. The back cord 42 of the tarpaulin apparatus 10 is tied to a support structure 56 to attach a back edge 16 of the flexible sheet 12 to the support structure 56. The support structure 56 may comprise a post, a tree, a fence, or any other suitable structure for mounting the back edge 16 of the flexible sheet 12. The back cord 42 is attached to the support structure 56 at an elevation equal to an elevation of the front edge 14 of the flexible sheet 12.

The payload 48 is positioned on the flexible sheet 12 over the ground surface. The vehicle 50 is operated, towed, or otherwise moved away from the support structure 56, thereby pulling the flexible sheet 12 taut between the vehicle 50 and the support structure 56. By pulling the flexible sheet 12 taut, the flexible sheet 12 extends horizontally between the back edge 16 of the flexible sheet 12 and the front edge 14 of the flexible sheet 12. The front rigid board 20 and the back rigid board 28 prevent the flexible sheet 12 from sagging between the side edges 18 of the flexible sheet 12.

The payload 48 is moved across the flexible sheet 12 such as by sliding or rolling the payload 48 in order to move the payload 48 to a carrying position in which the payload 48 rests on the flexible sheet 12 over the rack 52 of the vehicle 50. The back cord 42 is untied from the support structure 56 to detach the tarpaulin apparatus 10 from the support structure 56. The payload 48 is then wrapped in the flexible sheet 12 of the tarpaulin apparatus 10, and the back cord 42 of the tarpaulin apparatus 10 is tied to the vehicle 50 such that the payload 48 is secured in the carrying position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tarpaulin apparatus for facilitating lifting a payload onto a rack of a vehicle, the tarpaulin apparatus comprising:
a flexible sheet, a pair of side edges of the flexible sheet extending between a front edge and a back edge of the flexible sheet;
a front rigid board coupled to the flexible sheet adjacent to the front edge, the front rigid board extending between the pair of side edges of the flexible sheet; and
a back rigid board coupled to the flexible sheet adjacent to the back edge, the back rigid board extending between the pair of side edges of the flexible sheet.

2. The tarpaulin apparatus of claim 1, wherein the flexible sheet is elongated between the front edge and the back edge.

3. The tarpaulin apparatus of claim 1, further comprising a front cord coupled to the front rigid board, the front cord having a pair of end portions and a central portion, the central portion being coupled to and extending between the pair of end portions.

4. The tarpaulin apparatus of claim 3, wherein:
the flexible sheet is wrapped around a bottom side, a front side, and a top side of the front rigid board; and
the central portion of the front cord lies against the flexible sheet opposite the top side of the front rigid board, each end portion of the pair of end portions of the front cord extending away from the central portion through the flexible sheet, the front rigid board, and the flexible sheet again.

5. The tarpaulin apparatus of claim 1, further comprising a back cord coupled to the back rigid board, the back cord having a pair of end sections and a central section, the central section being coupled to and extending between the pair of end sections.

6. The tarpaulin apparatus of claim 5, wherein:
the flexible sheet is wrapped around a bottom surface, a back surface, and a top surface of the back rigid board; and
the central section of the back cord lies against the flexible sheet opposite the top surface of the back rigid board, each end section of the pair of end sections of the back cord extending away from the central section through the flexible sheet, the back rigid board, and the flexible sheet again.

7. A tarpaulin apparatus for facilitating lifting a payload onto a rack of a vehicle, the tarpaulin apparatus comprising:
a flexible sheet, a pair of side edges of the flexible sheet extending between a front edge and a back edge of the flexible sheet, the flexible sheet being elongated between the front edge and the back edge;
a front rigid board coupled to the flexible sheet adjacent to the front edge, the front rigid board extending between the pair of side edges of the flexible sheet, the flexible sheet being wrapped around a bottom side, a front side, and a top side of the front rigid board;
a back rigid board coupled to the flexible sheet adjacent to the back edge, the back rigid board extending between the pair of side edges of the flexible sheet, the flexible sheet being wrapped around a bottom surface, a back surface, and a top surface of the back rigid board;
a front cord coupled to the front rigid board, the front cord having a pair of end portions and a central portion, the central portion being coupled to and extending between the pair of end portions, the central portion of the front cord lying against the flexible sheet opposite the top side of the front rigid board, each end portion of the pair of end portions of the front cord extending away from the central portion through the flexible sheet, the front rigid board, and the flexible sheet again; and
a back cord coupled to the back rigid board, the back cord having a pair of end sections and a central section, the central section being coupled to and extending between the pair of end sections, the central section of the back cord lying against the flexible sheet opposite the top surface of the back rigid board, each end section of the pair of end sections of the back cord extending away from the central section through the flexible sheet, the back rigid board, and the flexible sheet again.

8. A method of lifting a payload onto a rack of a vehicle, the method comprising:
positioning a flexible sheet of a tarpaulin apparatus over the rack of the vehicle such that the tarpaulin apparatus extends across and off of the rack and onto a ground surface positioned below an upper surface of the rack;
attaching a front edge of the flexible sheet to the rack of the vehicle;
attaching a back edge of the flexible sheet to a support structure;
positioning the payload on the flexible sheet over the ground surface;
moving the vehicle away from the support structure, thereby pulling the flexible sheet taut between the vehicle and the support structure, whereby the flexible sheet extends horizontally between the back edge of the flexible sheet and the front edge of the flexible sheet; and
moving the payload across the flexible sheet to a carrying position in which the payload lies on the flexible sheet over the rack of the vehicle.

9. The method of claim 8, wherein the step of attaching the front edge of the flexible sheet to the rack of the vehicle comprises tying a front cord of the tarpaulin apparatus to the vehicle.

10. The method of claim 8, wherein the step of attaching the back edge of the flexible sheet to the support structure comprises tying a back cord of the tarpaulin apparatus to the support structure.

11. The method of claim 10, wherein the back cord is attached to the support structure at an elevation equal to an elevation of the front edge of the flexible sheet.

12. The method of claim 8, wherein the step of moving the vehicle away from the support structure comprises operating the vehicle to move the vehicle.

13. The method of claim 8, wherein the tarpaulin apparatus further comprises a front rigid board which is coupled to the flexible sheet at the front edge, the tarpaulin apparatus comprising a back rigid board which is coupled to the flexible sheet at the back edge, the front rigid board and the back rigid board extending between a pair of side edges of the flexible sheet.

14. The method of claim 8, further comprising detaching the tarpaulin apparatus from the support structure.

15. The method of claim 8, further comprising securing, via wrapping the payload in the flexible sheet of the tarpaulin apparatus and tying the back cord of the tarpaulin apparatus to the vehicle, the payload in the carrying position.
